(19) United States
(12) Patent Application Publication
(10) Pub. No.: US 2007/0162630 A1
(43) Pub. Date: Jul. 12, 2007

(54) Single-chip multiple-microcontroller package structure

(76) Inventor: Tsan-Bih Tang, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/295,578

(22) Filed: Dec. 7, 2005

(51) Int. Cl. G06F 3/00

(52) U.S. Cl. 710/14

(57) ABSTRACT

A single chip multiple-microcontroller package structure comprises at least two microcontrollers capable of operating independently, a plurality of pins, a data bus, a pin multiple-control register, and a plurality of pin control logics. The pin multiple-control register, the data bus, and the pin control logics are electrically connected to the pins. The microcontrollers can be electrically connected to at least a specific pin in the pins at the same time so that the specific pin can be dynamically controlled by the microcontrollers for data access and function change of the specific pin. The single chip multiple-microcontroller package structure can therefore provide more functions and higher flexibility with the least pins.

### BACKGROUND OF THE INVENTION

1. Field of the Invention

The present invention relates to a single chip package structure and, more particularly, to a single chip multiple-microcontroller package structure.

2. Description of Related Art

Single chip microcontrollers gradually replace the role of conventional electronic circuits or logic circuits in the automation field because of their high integration, simple hardware structure, low power consumption, and high flexibility. They are widely applied in various industries, home electric products or equipments, and so on. It is evident that single chip microcontrollers will inevitably be the most important main control elements for future automation. Moreover, under the requirements of compactness of electric products, for a single chip microcontroller to provide the most functions with the smallest package, more functions need to be provided for a single pin.

In response to different applications and interface demands, the microcontroller architecture has some pins with specific functions and some general purpose IOI (GPIO) pins. Customers are allowed to set the function of the GPIO pin in microcontroller programs according to their demands. Briefly speaking, it is necessary to provide more pin control methods and more operational functions of microcontroller to enhance the GPIO function. Today's microcontrollers can be divided into 8-bit, 16-bit, and 32-bit series. The larger number of bit, the more complicated the usable instruction set, and the more functions that can be provided. No matter what the specification is, a package structure 10 of a common single chip microcontroller is shown in FIG. 1. The package structure 10 has a microcontroller 12 and a plurality of GPIO pins (e.g., pin 14). As shown in FIG. 1, the microcontroller 12 sets the input output mode of the pin via a pin control register 11. The microcontroller 12 selects a corresponding pin 14 via a data bus 18 and a pin control logic 16 to accomplish bidirectional transmission of signal. The package structure 10 utilizes the microcontroller 12 to control the pin 14, and provides functions for the pin 14 by means of program.

The present invention aims to propose a single-chip package structure of multiple-microcontroller so that at least two microcontrollers in the multiple-microcontroller can control the same pin, and can change the function of the pin according to the requirements of the system specification. As compared to the prior art, the present invention can provide more functions and higher flexibility.

### SUMMARY OF THE INVENTION

An object of the present invention is to provide a single chip multiple-microcontroller package structure, in which at least two microcontrollers can be connected to the same pin so that the pin can be dynamically controlled by several microcontrollers for data access, thereby providing more functions for the single pin.

Another object of the present invention is to provide a single chip multiple-microcontroller package structure, in which the function of at least a pin can be dynamically changed by programs of different microcontrollers so that the pin can generate the desired function according to the corresponding microcontroller to expand the range of applications.

According to the present invention, a single chip multiple-microcontroller package structure comprises at least two microcontrollers each capable of executing at least a program. Each microcontroller is connected to a pin multiple-control register to read the current setting status of pin to check whether the pin is available and set the input output mode of pin. The microcontrollers are electrically connected to a plurality of pins via a data bus and a plurality of pin control logics so that the microcontrollers can be electrically connected to at least a specific pin in the pins at the same time. Moreover, if the package structure has three or more microcontrollers, it is sufficient that only at least two of the microcontrollers are electrically connected to the same specific pin. Of course, the microcontrollers connected to the same specific pin can dynamically change the function of the pin to control its operations.

### BRIEF DESCRIPTION OF THE DRAWINGS

The various objects and advantages of the present invention will be more readily understood from the following detailed description when read in conjunction with the appended drawing, in which:

FIG. 1 is a package structure diagram of a conventional single chip microcontroller; and

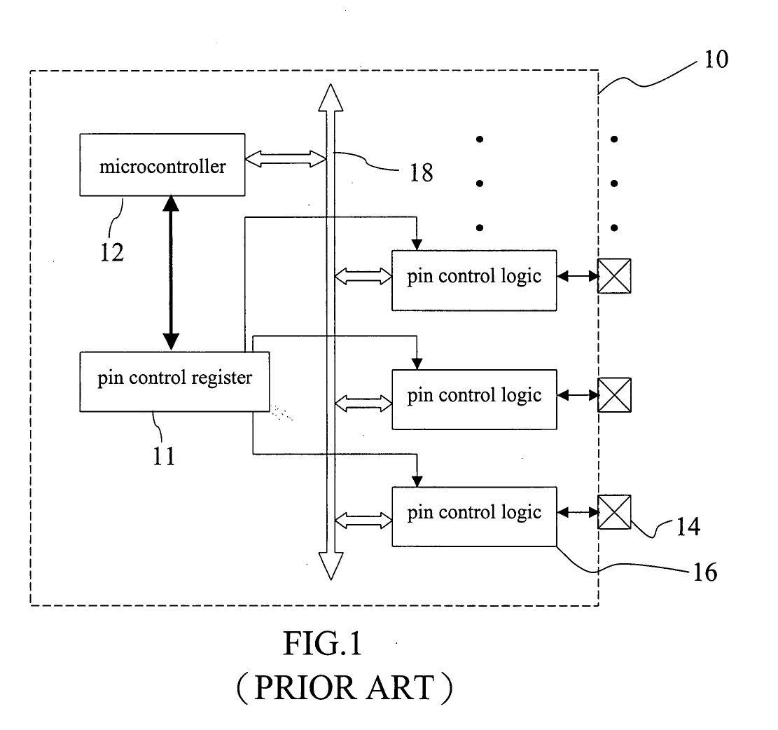

FIG. 2 is a diagram of a single chip package structure of the present invention.

### DETAILED DESCRIPTION OF THE PREFERRED EMBODIMENTS

The present invention proposes a single chip multiple-microcontroller package structure, in which at least two microcontrollers in the single chip package structure can be connected to the same pin and each microcontroller can access the input/output pin through its own program instructions so that the pin can be dynamically controlled by several microcontrollers for data access, thereby providing more functions for a single pin and accomplishing a wider range of applications. In the present invention, a plurality of microcontrollers can be provided in a single chip package structure. The present invention will be exemplified below with three microcontrollers.

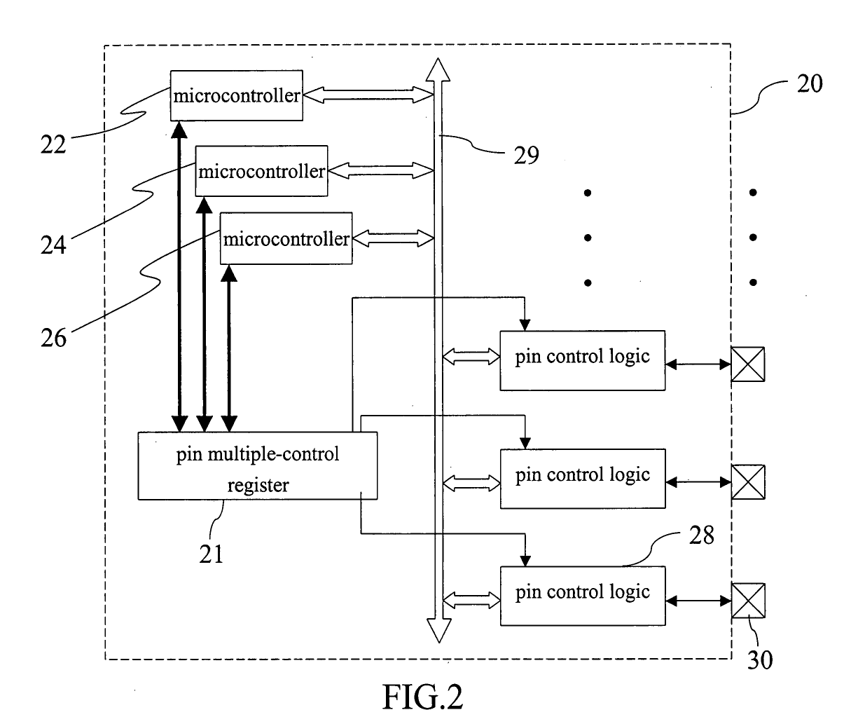

As shown in FIG. 2, a single chip multiple-microcontroller package structure 20 comprises three microcontrollers (a first microcontroller 22, a second microcontroller 24 and a third microcontroller 26), several pin control logics 28. Each of the microcontrollers 22, 24 and 26 is connected to a pin multiple-control register 21 to read the current setting status of pin to check whether the pin is available and to set the input output mode of pin. Each of the microcontrollers 22, 24 and 26 is also connected to a data bus 29. The pin control logics 28 are connected to the data bus, and electrically connect the microcontrollers 22, 24 and 26 to a plurality of pins for data transmission between the microcontrollers 22, 24 and 26 and the pins. As shown in the figure, the microcontrollers 22, 24 and 26 can be electrically connected to a specific pin 30 at the same time. This specific pin 30 is a multifunctional pin, and can be dynamically controlled by the microcontrollers 22, 24 and 26 at the same time. When one wants the specific pin 30 to have the function of setting the first microcontroller 22, the first microcontroller 22 reads the current status of the multiple-control register 21 and sets the input output mode of the specific pin 30. Next, the first microcontroller 22 performs data transmission with the specific pin 30 via the data bus 29 and the corresponding pin control logic 28. When one wants the specific pin 30 to have the function of setting the second microcontroller 24, the second microcontroller 24 reads the current status of the multiple-control register 21 and sets the input output mode of the specific pin 30. Next, the second microcontroller 24 performs data transmission with the specific pin 30 via the data bus 29 and the corresponding pin control logic 28. When one wants the specific pin 30 to have the function of setting the third microcontroller 26, the third microcontroller 26 reads the current status of the multiple-control register 21 and sets the input output mode of the specific pin 30. Next, the third microcontroller 26 performs data transmission with the specific pin 30 via the data bus 29 and the corresponding pin control logic 28.

Of course, in the above embodiment, all the three microcontrollers 22, 24 and 26 in the single chip package structure 20 can connect and control the specific pin 30. If the package structure has three or more microcontrollers, it is sufficient that only at least two of the microcontrollers are electrically connected to the same specific pin. Moreover, the present invention can also apply to chip on board (COB) structures.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A single chip multiple-microcontroller package structure comprising:
a plurality of pins used as input/output contacts of signal;
at least two microcontrollers each capable of executing at least a program;
a data bus used for data transmission of said microcontrollers and said pins;
a pin multiple-control register connected to said microcontrollers to receive settings of said microcontrollers for controlling input/output of said pins; and
a plurality of pin control logics connected to said pin multiple-control register to separately receive input/output mode settings of said pins, said pin control logics being also electrically connected to said data bus to electrically connect said microcontrollers to at least a specific pin in said pins.

2. The single chip multiple-microcontroller package structure as claimed in claim 1, wherein said specific pin is dynamically controlled by said microcontrollers at the same time.

3. The single chip multiple-microcontroller package structure as claimed in claim 1, wherein if there are three or more said microcontrollers, it is sufficient that only at least two of said microcontrollers are electrically connected to said specific pin.

4. The single chip multiple-microcontroller package structure as claimed in claim 1, wherein said specific pin is a multifunctional pin, and its function can be dynamically changed by each of said microcontrollers.

5. The single chip multiple-microcontroller package structure as claimed in claim 4, wherein the function of said specific pin can be changed to correspond to each of said microcontrollers.

6. The single chip multiple-microcontroller package structure as claimed in claim 5, wherein the function of said specific pin is changed by using a program of each of said microcontrollers.
